(19) United States
(12) Patent Application Publication
(10) Pub. No.: US 2015/0089454 A1
(43) Pub. Date: Mar. 26, 2015

(54) OVERSCROLL STRETCH ANIMATION

(71) Applicant: Kobo Incorporated, Toronto (CA)

(72) Inventors: James WU, Toronto (CA); Daniel HILL, Toronto (CA); Robin BENNETT, Toronto (CA)

(73) Assignee: Kobo Incorporated, Toronto (CA)

(21) Appl. No.: 14/036,604

(22) Filed: Sep. 25, 2013

(51) Int. Cl. G06F 3/0488

(52) U.S. Cl. CPC G06F 3/0488
USPC 715/863

(57) ABSTRACT

Overscroll stretch animation. In accordance with a first method embodiment, a portion of displayable information is displayed on a touch screen display in a nominal state. A movement of an object on or near the touch screen display is detected. Responsive to the movement, a boundary limit of the displayable information is detected. Responsive to the detecting, the portion of displayable information is displayed in a distorted state. The distorted state simulates fabric stretching.

### FIELD OF INVENTION

Embodiments of the present invention relate to the field of devices with electronic displays. More specifically, embodiments of the present invention relate to systems and methods for overscroll stretch animation.

### BACKGROUND

Portable electronic systems, e.g., “smart” phones, tablets, and/or personal digital assistants, “wearable” electronic systems, including, e.g., “smart” watches and/or glasses, may generally only display a limited view of available information at any level of an information hierarchy. For example, such devices generally display a limited view of a document, a limited view of a list of documents, or a limited view of a list of other available features of a hand held computer system. For example, a portable electronic system may include hundreds to thousands of documents, media files or available programs, e.g., “apps.” However, the portable electronic system may only conveniently display icons representing a relatively small number, e.g., six to 12, of such icons on a single display image or “screen.”

It is common to scroll a display image, using gestures input via a touch screen, to scroll or move among various displayed subsets of such images. For example, a “sweeping” gesture may move from a first image of a first group of icons to a second image of a second group of icons. Such scrolling, also known as or referred to as “translating,” presents a user with a graphical user interface (GUI) metaphor of viewing a portion of a larger “app space” or “document space” through a smaller display-sized window.

It is a challenge for such graphical user interfaces to communicate various “events,” such as reaching an end or edge of such an “app space” or “document space,” in an intuitive manner.

### SUMMARY OF THE INVENTION

Therefore, what is needed are systems and methods for overscroll stretch animation that provide intuitive feedback to a user. What is additionally needed are systems and methods for overscroll stretch animation that simulates stretching fabric as intuitive feedback to a user upon reaching a boundary of displayable information. A further need exists for systems and methods for overscroll stretch animation that are compatible and complementary with existing systems and methods of electronic display operation and programming. Embodiments of the present invention provide these advantages.

In accordance with a first method embodiment, a portion of displayable information is displayed on a touch screen display in a nominal state. A movement of an object on or near the touch screen display is detected. Responsive to the movement, a boundary limit of the displayable information is detected. Responsive to the detecting, the portion of displayable information is displayed in a distorted state. The distorted state simulates fabric stretching.

In accordance with another embodiment of the present invention, a computer system includes a touch screen display, at least one processor, a memory and one or more programs stored in the memory. The one or more programs are configured to be executed by the at least one processor to control the computer system to display a portion of displayable information in a nominal state on the touch screen display, detect a movement of an object on or near the touch screen display, responsive to the movement, detect a boundary limit of the displayable information, and responsive to a detection of the boundary limit, display the portion of displayable information in a distorted state on the touch screen display, wherein the distorted state changes a shape of items of the portion of displayable information.

In accordance with a further embodiment of the present invention, an article of manufacture including a computer readable medium having instructions stored thereon that, responsive to execution by an electronic system, cause the electronic system to perform operations including displaying a portion of displayable information in a nominal state, detecting a movement of an object on or near a touch screen display, responsive to the movement, detecting a boundary limit of the displayable information, and responsive to the detecting, displaying the portion of displayable information in a distorted state, wherein the distorted state simulates fabric stretching.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1A illustrates an exemplary front view of a portable electronic system, which may be used as a platform to implement embodiments of the present invention.

FIG. 1B is an exemplary block diagram of an exemplary portable electronic system, which may be used as a platform to implement embodiments of the present invention.

FIG. 2 illustrates an exemplary portion of user interface displayed on display of a portable electronic system, in accordance with embodiments of the present invention

FIG. 3 illustrates a distortion of displayed cells, in accordance with embodiments of the present invention.

FIG. 4 illustrates distortion of displayed cells, in accordance with embodiments of the present invention.

FIG. 5 illustrates a distortion of displayed cells, in accordance with embodiments of the present invention.

FIG. 6 illustrates a distortion of displayed cells, in accordance with embodiments of the present invention.

FIG. 7 illustrates a distortion of a displayed cell, in accordance with embodiments of the present invention.

FIG. 8 illustrates two images of a display of cells, in accordance with embodiments of the present invention.

FIG. 9 illustrates a method, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow (e.g., method 900) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “displaying” or “detecting” or “determining” or “setting” or “accessing” or “placing” or “testing” or “forming” or “mounting” or “removing” or “ceasing” or “stopping” or “coating” or “attaching” or “processing” or “performing” or “generating” or “adjusting” or “creating” or “executing” or “continuing” or “indexing” or “computing” or “translating” or “calculating” or “determining” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As used herein, the term “picture element” or “pixel” is used to refer to or to describe the smallest portion of an electronic display that may be discriminated, e.g., directly addressed and/or controlled. For example, for a display described as having a resolution of 256 dots per inch (DPI), there are 256 pixels per inch.

As used herein, the term “cell” is used to refer to or to describe a group of picture elements. A cell may be any suitable size and/or shape.

As used herein, the term “icon” is used as understood by those of ordinary skill in the electronic arts. For example, an icon is generally understood to comprise an image on a computer generated display that represents a specific file, e.g., an electronic book, audio or video file, directory, window, option or program, e.g., “app.” Selection of an icon, e.g., “clicking” with a mouse or touching an icon on a touch screen display, generally launches software appropriate for that specific file type. For example, selection of a “music file” icon will initiate an audio player software and play the particular music selection.

### Overscroll Stretch Animation

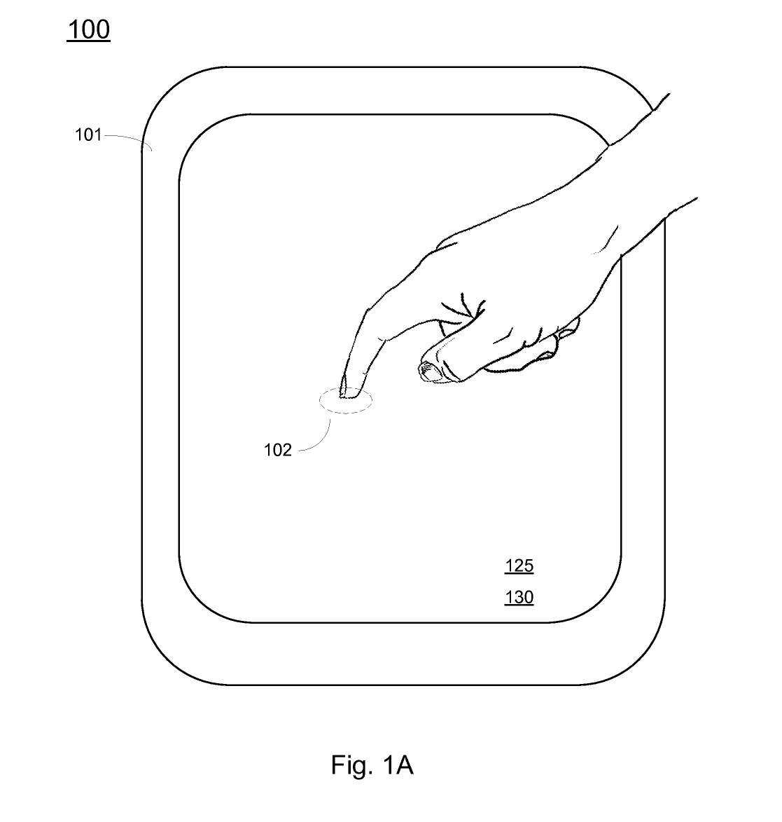

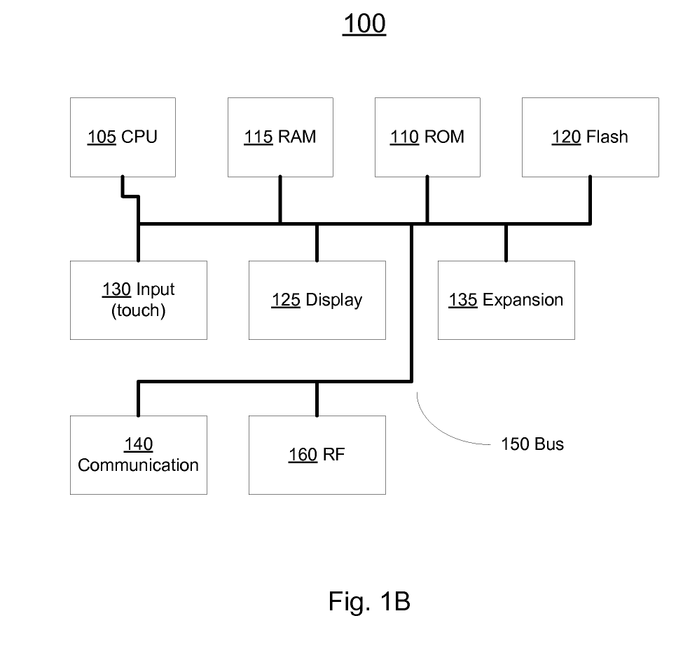

FIG. 1A illustrates an exemplary front view of a portable electronic system 100, which may be used as a platform to implement embodiments of the present invention. Portable electronic system 100 may comprise, for example, a “smart” phone, a tablet, and/or a personal digital assistant. Portable electronic system 100 may also comprise, for example, a “wearable” electronic system, including, e.g., a “smart” watch and/or glasses. Portable electronic system 100 is enclosed in a case or shell 101 of any suitable material. In some embodiments, various portions of portable electronic system 100 may be contained in multiple enclosures. For example, CPU 105 may be housed separately from display 125. Portable electronic system 100 comprises a display unit 125 and may comprise a touch sensitive digitizer panel 130, also known as or referred to as a “touch screen.” Touch sensitive digitizer panel 130 operates to indentify a point of contact 102 of a finger, stylus or other object. Item 102 may correspond to a cursor image on display 125, in some embodiments.

FIG. 1B is an exemplary block diagram of an exemplary portable electronic system 100, which may be used as a platform to implement embodiments of the present invention. Electronic system 100 may be battery-powered, in some embodiments. Electronic system 100 includes an address/data bus 150 for communicating information, a central processor 105 functionally coupled with the bus for processing information and instructions. Central processor 105 may comprise multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the portable electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a weapon-mounted and/or head-mounted display, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may consist of signals substantially compliant with the signals of bus 150.

A wide variety of well known devices may be attached to electronic system 100 via the bus 150 and/or expansion interface 135. Examples of such devices include without limitation rotating magnetic memory devices, flash memory devices, digital cameras, wireless communication modules, digital audio players and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of portable electronic system 100 may be implemented by a combination of hardware and/or software. Portable electronic system 100 may comprise additional software and/or hardware features (not shown) in some embodiments.

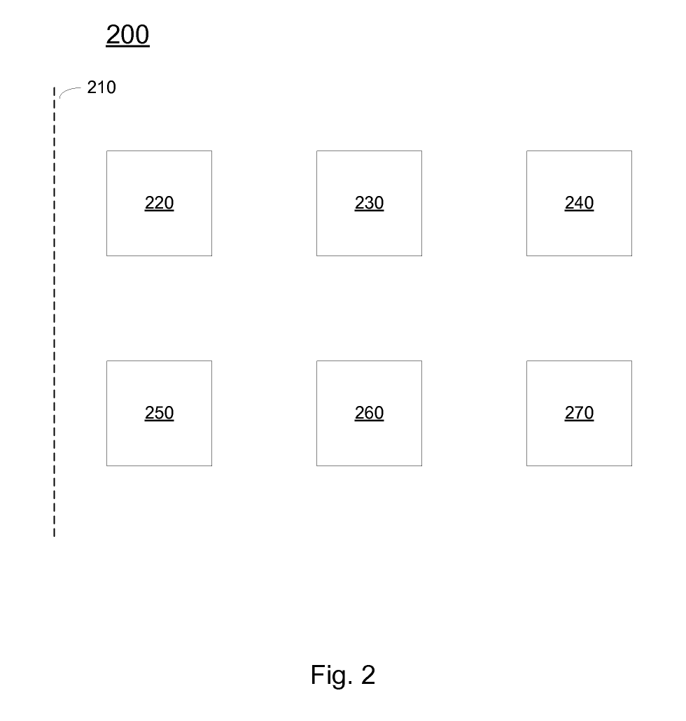

FIG. 2 illustrates an exemplary portion of user interface 200 displayed on display 125 of portable electronic system 100 (FIG. 1B), in accordance with embodiments of the present invention. Cells 220, 230, 240, 250, 260 and 270 illustrate a nominal state of displayed information of user interface 200. Cells 220-270 may represent any displayable information of electronic system 100. For example, cells 220-270 may represent icons corresponding to documents, e.g., e-reader book files, media files, e.g., pictures, audio files, video files, directories, application programs (“apps”) and/or other files available on portable electronic system 100. Alternatively, cells 220-270 may represent portions of a single document or media file. For example, cells 22-270 may represent letters and/or words, or arbitrary groupings of letters and/or words in a document, e.g., a page or partial page of a book. Cells 220-270 may also represent, for example, portions of a single document or image, e.g., a web page. Cells 220-270 may be discrete, e.g., separated from one another, or they may be contiguous.

Line 210 represents the left most limit, or space boundary, of available displayable information. For example, the displayed portion of user interface 200 may represent a window into a greater whole or “space” of information, such as icons, and/or files available on portable electronic system 100. A user may navigate, e.g., scroll, throughout the greater information space by virtual movement of the window, e.g., displayed image, within the greater space. Line 210 represents to the left most limit of such a greater space. Line 210 is not typically displayed. Similarly, there are upper, lower and right limits (not shown) or boundaries that are a part of the graphical user interface metaphor, which are generally not displayed. Accordingly, cells 220-270 are the “left most” cells that may be displayed.

In accordance with embodiments of the present invention, displayed cells, e.g., cells 220-270, may be distorted to indicate that a space boundary such as line 210 has been reached in response to a user attempting to scroll beyond the limits of boundary 210, e.g., “overscroll.” Alternatively, in accordance with embodiments of the present invention, displayed cells, e.g., cells 220-270, may be distorted responsive to an “overscroll,” for example, receipt of a command, e.g., a gesture, to scroll beyond a space boundary. A “scroll” gesture may comprise a finger or stylus moving in a substantially linear manner across a touch sensitive panel, e.g., touch panel 130 (FIG. 1B).

Embodiments in accordance with the present invention are well suited to any abstraction of icon and display movement. For example, in a first abstraction, a displayed image represents a moveable window that shows a portion of a fixed field of icons. In such a first abstraction, movement gestures are understood to move the window. A second abstraction may have a fixed window in which a field of icons moves through. In such a second abstraction, movement gestures are understood to move the icons. Some computer systems may allow a user to select among such abstractions. For example, the “scroll lock” key on many personal computers allows a user, in some application programs, to select among such abstractions. Embodiments in accordance with the present invention are well suited to any abstraction of icon and display movement.

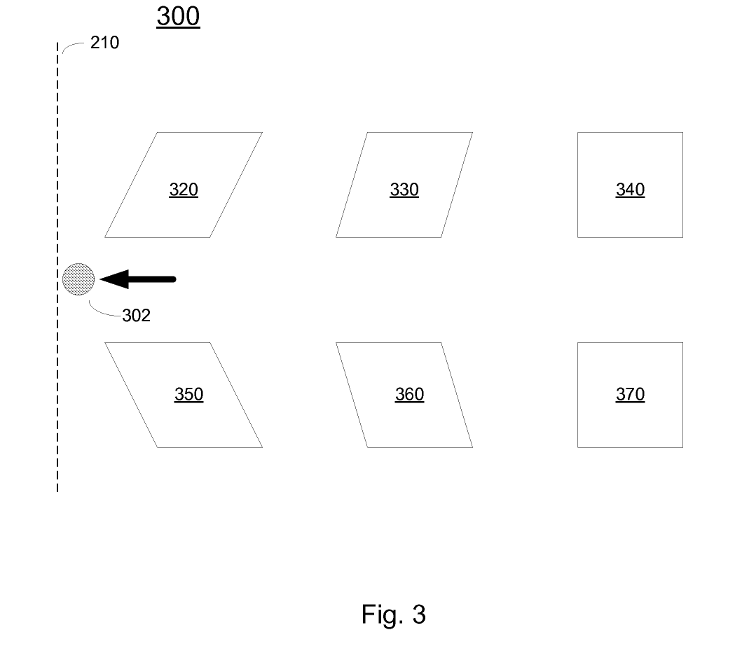

FIG. 3 illustrates a distortion 300 of displayed cells, in accordance with embodiments of the present invention. As the displayed cells are at the left most limit or boundary of the underlying display space, no further scrolling to the left is permitted. In response to a left “scroll” gesture 302, e.g., an overscroll, the cells 320, 330, 350 and 360 are distorted, in accordance with embodiments of the present invention. Such distortion of the cells provides feedback to a viewer of the portable electronic system that a limit or boundary of the underlying display space has been reached.

In accordance with embodiments of the present invention, distortion 300 is based on a metaphor of simplified stretching of fabric. The illustrated distortion of cells corresponds to a stretching of fabric toward the point of contact 302. For example, cells 320 and 350 are closest to the point of contact 302, and are distorted more than cells 330 and 360, which are farther away from the point of contact 302. Cells 340 and 370 are the farthest away from the point of contact 302, and may show little or no distortion, in some embodiments.

It is to be appreciated that the distortion of all illustrated cells is not identical. For example, as the point of contact 302 is below cell 320, the bottom of cell 320 is distorted or stretched more than the top of cell 320. In contrast, as the point of contact 302 is above cell 350, to top of cell 350 is distorted or stretched more than the bottom of cell 350. In other embodiments, all displayed cells may have the same amount of distortion.

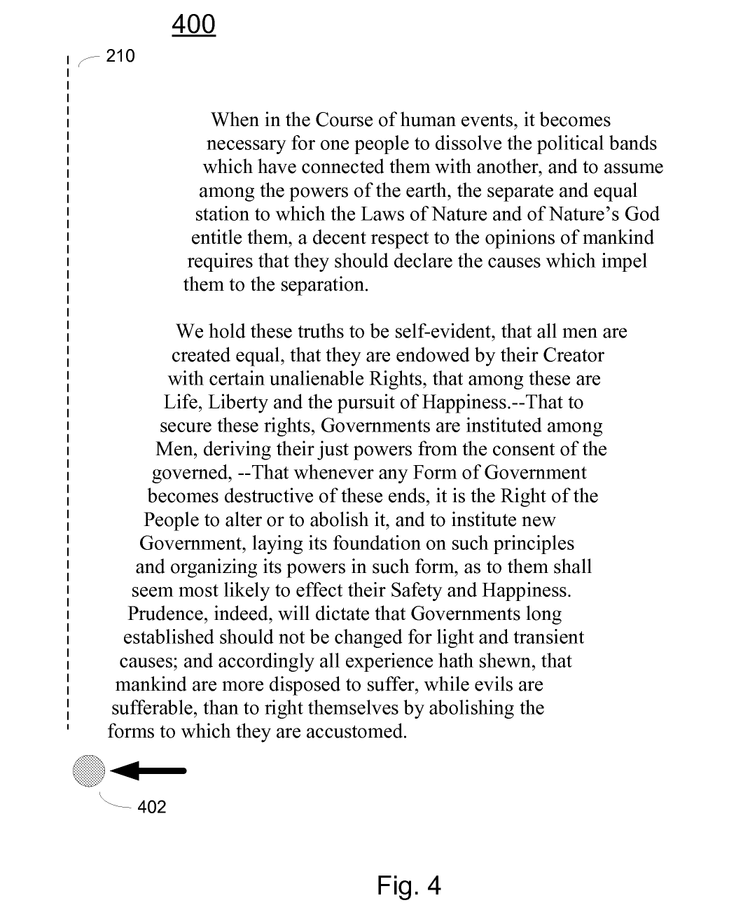

FIG. 4 illustrates distortion 400 of displayed cells, in accordance with embodiments of the present invention. FIG. 4 may be considered to display one or more cells. The content of the cell(s) illustrated is substantially textual. The cell(s), e.g., the textual content is distorted in the direction of the point of contact 402, responsive to an overscroll in the left direction.

The distortions presented in FIGS. 3 and 4 are in one dimension, e.g., the dimension of the scroll gesture, e.g., left as illustrated. The distortions presented in FIGS. 3 and 4 are also substantially linear in the given direction. For example, each display line of a particular cell is shifted in the direction by the same number of pixels. It is appreciated that the shift may be a partial pixel per display line, resulting is slight “jumps,” e.g., when the accumulated shift of fractional pixels is greater than one pixel.

In addition, cells may be shifted at a different scale, in accordance with embodiments of the present invention. For example, cells comprising interior shapes, graphics and/or symbols may implement a “stair-step” shift to avoid or limit distorting such interior shapes, while approximating an overall distortion of a cell, as illustrated in FIGS. 3 and 4.

In addition, cells comprising textual information may be shifted based on a line of text, e.g., generally comprising multiple display lines, rather than on a display line basis. For example, the illustrated shift of FIG. 4 is on a text-line basis, e.g., each line of text is shifted relative to the line above. Such text-line based shifting may maintain readability. As illustrated, the textual information of FIG. 4 is set with a “ragged right” edge. Embodiments in accordance with the present invention are well suited to other styles of typesetting, including, for example, full justification, no justification, and right and/or left alignment.

In accordance with embodiments of the present invention, distortions corresponding in other directions may be presented responsive to overscroll commands to move beyond limits in any direction, including the cardinal directions, e.g., up, down, left, right, and in other directions, e.g., intermediate or diagonal directions.

In addition to substantially linear one-dimensional distortions previously presented, other forms of distortions are envisioned in keeping with the metaphor of stretching fabric, in accordance with embodiments of the present invention.

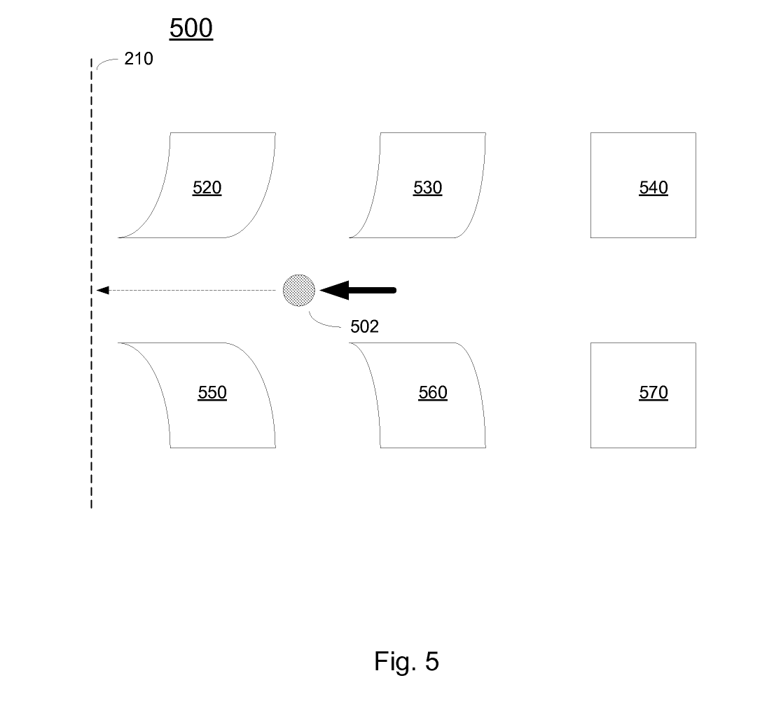

FIG. 5 illustrates a distortion 500 of displayed cells, in accordance with embodiments of the present invention. As the displayed cells are at the left most limit or boundary of the underlying display space, no further scrolling to the left is permitted. In response to a left “scroll” gesture 502, e.g., an overscroll, the cells 520, 530, 550 and 560 are distorted, in accordance with embodiments of the present invention. Such distortion of the cells provides feedback to a viewer of the portable electronic system that a limit or boundary of the underlying display space has been reached.

The distortion 500 is non-linear in the direction of the scroll gesture 502. For example, the distortion of cell 520 increases non-linearly from the top to the bottom of the cell. Such a distortion pattern may be a more complex and more accurate model of fabric stretching.

The illustrated distortion of cells 500 corresponds to a stretching of fabric in the direction of the overscroll gesture, e.g., to the left in FIG. 5. For example, cells 520 and 550 are closest to the boundary limit 210, and are distorted more than cells 530 and 560, which are farther away from the boundary limit 210. Cells 540 and 570 are the farthest away from the boundary limit 210, and may show little or no distortion, in some embodiments. For example, the limit line 210 guides the distortion, even if an actual point of contact does not reach the limit line 210.

It is to be appreciated that the distortion of all cells is not identical. For example, as the line of gesture 502 is below cell 520, the bottom of cell 520 is distorted or stretched more than the top of cell 520. In contrast, as the line of gesture 502 is above cell 550, to top of cell 550 is distorted or stretched more than the bottom of cell 550. For example, the line of gesture 502 guides the distortion, even if an actual point of contact does not reach the limit 210.

It is appreciated that the points of stretching for distortions 300 (FIG. 3) and 500 are different. In distortion 300, the stretching distortion is “aimed” at the point of contact 302 (FIG. 3). In contrast, in distortion 500, the stretching distortion is aimed at the intersection of limit 210 and a line of the overscroll gesture 502. Embodiments in accordance with the present invention are well suited to either method of guiding a fabric stretching distortion.

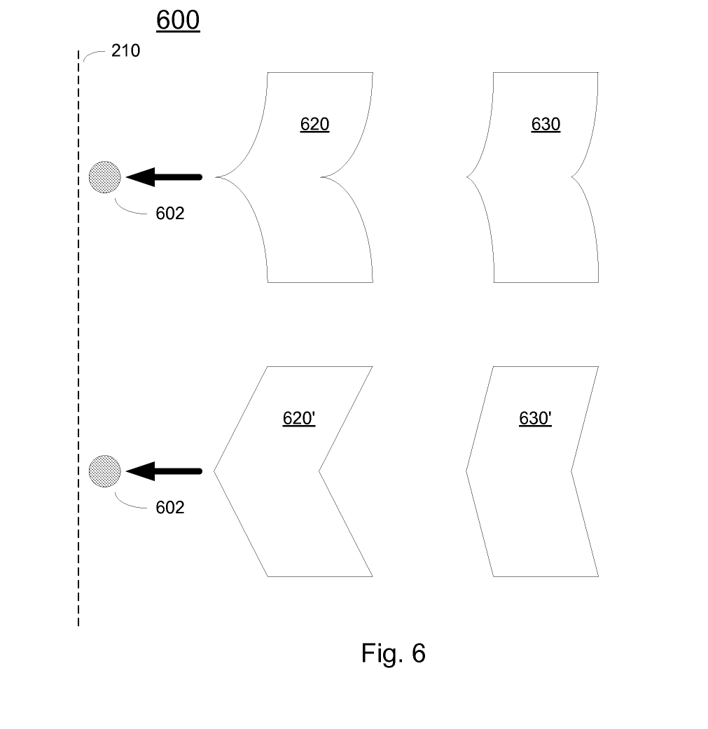

FIG. 6 illustrates a distortion 600 of displayed cells, in accordance with embodiments of the present invention. As the displayed cells are at the left most limit or boundary of the underlying display space, no further scrolling to the left is permitted. In response to a left “scroll” gesture 602, e.g., an overscroll, the cells 620 and 630 are distorted, in accordance with embodiments of the present invention. As the point of contact 602 is within the vertical extent of the cells 620 and 630, e.g., between the top and the bottom of cells 620, 630, the fabric-stretching distortion follows a complex, non-continuous curve focused or “aimed” at the point of contact 602. As illustrated, the line of the gesture 602 is about in the middle of the cells 620, 630, and the distortion of the cells is substantially symmetrical about the mid line of the cells, although that is not required. It is to be appreciated that the inflection of the complex distortion of the cells aligns with the line of the gesture 602, in some embodiments.

The illustrated distortion of cells 600 corresponds to a stretching of fabric in the direction of the overscroll gesture, e.g., to the left in FIG. 6. For example, cell 620 is closest to the boundary limit 210, and is distorted more than cell 530, which is farther away from the boundary limit 210. For example, the limit line 210 guides the distortion, even if an actual point of contact does not reach the limit line 210.

Embodiments in accordance with the present invention are also well suited to complex linear fabric-stretching distortions as illustrated in cells 620′ and 630′

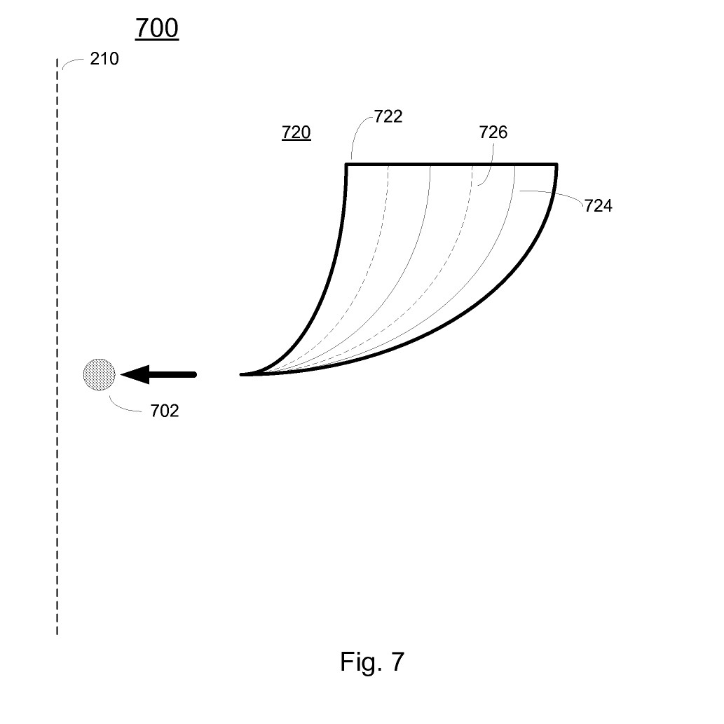

FIG. 7 illustrates a distortion 700 of a displayed cell, in accordance with embodiments of the present invention. As the displayed cell is at the left most limit or boundary of the underlying display space, no further scrolling to the left is permitted. In response to a left “scroll” gesture 702, e.g., an overscroll, the cell 720 is distorted, in accordance with embodiments of the present invention.

Cell 720 comprises a cell boundary or outline 722, indicated by a heavy dark line. Call 720 also comprises a plurality of prominences or ridge lines 724, indicated by solid lines, and a plurality of troughs or valleys 726, indicated by dashed lines. The plurality of prominences 724 and plurality of troughs 726 may be illustrated by any suitable graphical means, including, for example, use of color, shading and/or shadowing. The plurality of prominences 724 in combination with the plurality of troughs 726, e.g., the combination of highs and lows, indicate bunching of stretched fabric, in accordance with embodiments of the present invention. The distortion may converge to approximately a single point, however that is not required.

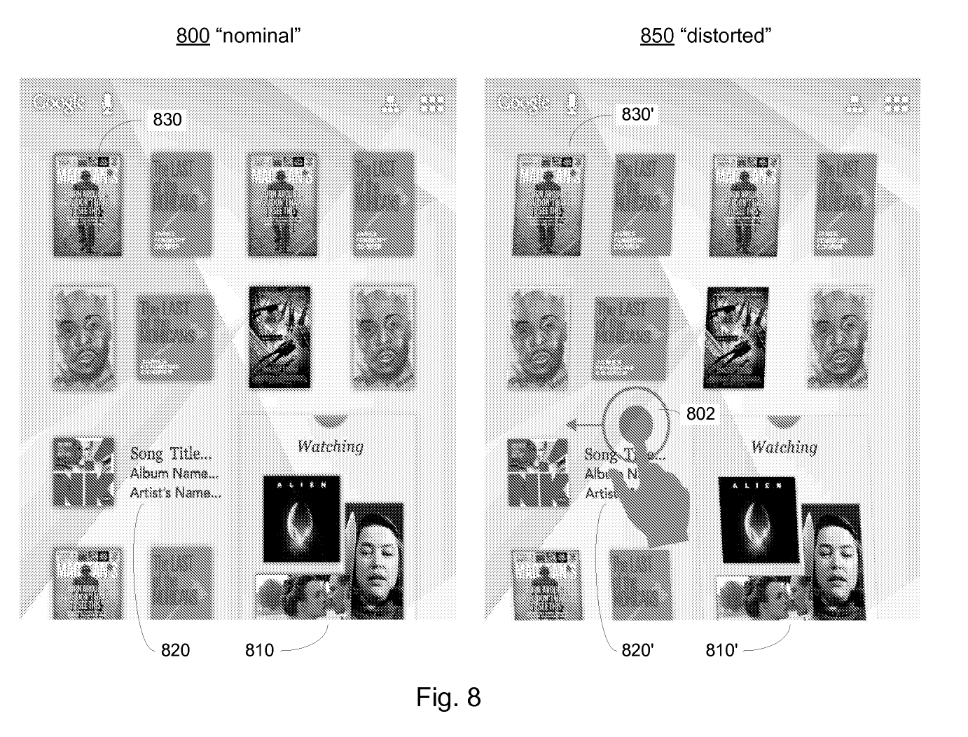

FIG. 8 illustrates two images of a display of cells, in accordance with embodiments of the present invention. The two images may be considered “screen shots.” In FIG. 8 the cells generally correspond to discrete icons, e.g., images representing application software or “apps,” magazine articles, books, audio and/or video files. It is to be appreciated that cells are not required to correspond to icons, and may be contiguous, in accordance with embodiments of the present invention.

Image 800 illustrates a plurality of cells, including cells 810 and 820. The cells are in a nominal or normal condition, e.g., undistorted. It is appreciated that cell 810 is larger than most of the other cells. It is also appreciated that cell 820 is primarily textual. Cell 830 is in the top row of displayed cells. Image 850 illustrates a plurality of cells in a distorted state. In response to a left “scroll” gesture 802, e.g., an overscroll, the cells are distorted, e.g., the portions of the cells closest to the point of contact 802 are distorted in the direction of the scroll gesture, e.g., to the left. Cells 810′ and 820′, being below the line of the gesture 802, are distorted such that they appear to “lean” to the left. Cells above the line of gesture 802, e.g., cell 830′, are distorted such that they appear to “lean” to the right. In some embodiments, the bottom of cell 830′ has shifted, rather than the top of cell 830′. It is appreciated that the illustrated distortion of image 850 simulates or models fabric being stretched in the direction of the scroll gesture, in accordance with embodiments of the present invention.

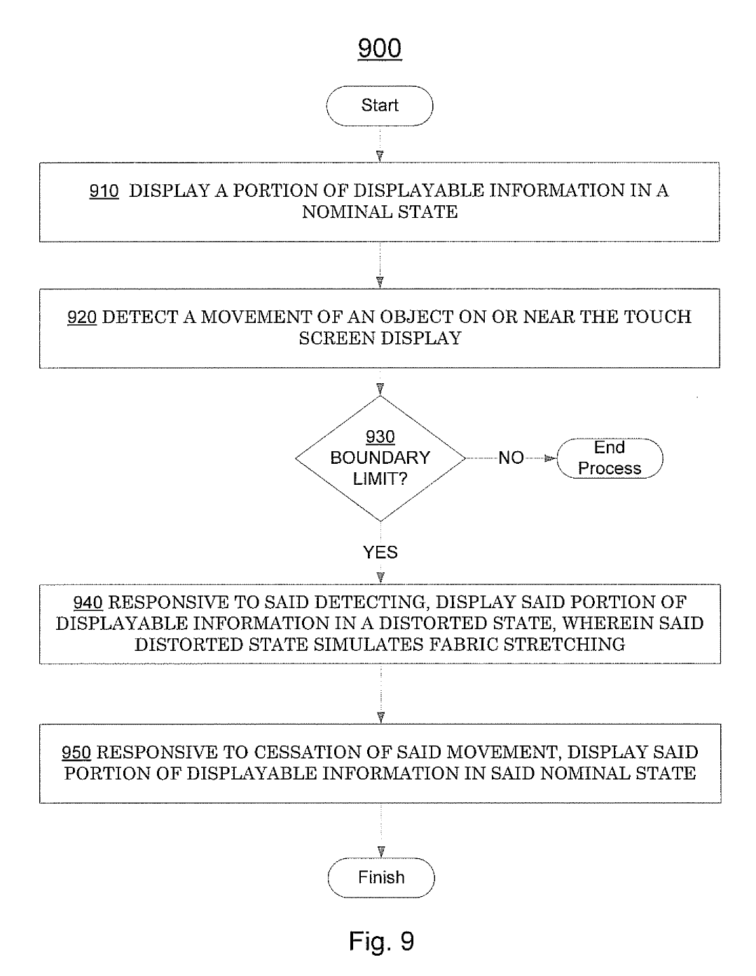

FIG. 9 illustrates a method 900, in accordance with embodiments of the present invention. In 910, an electronic system, e.g., portable electronic system 100 of FIG. 1A, displays a portion of displayable information in a nominal state.

In 920, a movement of an object on or near the touch screen display is detected. The movement may represent a scroll gesture received by a touch screen. The object may be, for example, a user's finger or a stylus. In 930, a boundary limit of the displayable information is detected. In 940, responsive to the detection of the boundary limit, the portion of displayable information is displayed in a distorted state. The distortion may model or simulate fabric stretching.

In optional 950, responsive to cessation of the movement, the portion of displayable information is displayed in a nominal state. For example, the distortion effect is removed or stopped. In this novel manner, a user is provided intuitive feedback as to a boundary of displayable information. Accordingly, the graphical user interface is improved, and the electronic system is beneficially more usable.

In accordance with some embodiments of the present invention, a scroll or translate command is not required to be received by a touch panel, e.g., touch sensitive panel 130 of FIG. 1B. Other suitable forms of input, for example, discrete buttons, joysticks, track balls, eyeball trackers, biofeedback mechanisms and/or voice commands, for entering commands to a portable electronic system are well suited to embodiments in accordance with the present invention, and are considered within the scope of the present invention.

Embodiments in accordance with the present invention provide systems and methods for overscroll stretch animation that provide intuitive feedback to a user. In addition, embodiments in accordance with the present invention provide systems and methods for overscroll stretch animation that simulates stretching fabric as intuitive feedback to a user upon reaching a boundary displayable information. Further, embodiments in accordance with the present invention provide systems and methods for overscroll stretch animation that are compatible and complementary with existing systems and methods of electronic display operation and programming.

Various embodiments of the invention are thus described. While the present invention has been described in particular embodiments, it should be appreciated that the invention should not be construed as limited by such embodiments, but rather construed according to the below claims.

What is claimed is:

1. A computer implemented method comprising:
at a device comprising a touch screen display:
displaying a portion of displayable information in a nominal state;
detecting a movement of an object on or near said touch screen display;
responsive to said movement, detecting a boundary limit of said displayable information; and
responsive to said detecting, displaying said portion of displayable information in a distorted state, wherein said distorted state simulates fabric stretching in a direction of said movement.

2. The method of claim 1 wherein said movement is in a horizontal direction.

3. The method of claim 1 wherein said movement is in a vertical direction.

4. The method of claim 1 wherein said movement is in a direction that is neither horizontal nor vertical.

5. The method of claim 1 wherein said portion of displayable information comprises at least one icon.

6. The method of claim 1 wherein said portion of displayable information comprises a majority of textual information.

7. The method of claim 1 wherein said portion of displayable information comprises a portion of a web page.

8. The method of claim 1 wherein said distorted state comprises a linear shift of said portion of displayable information.

9. A computer system comprising:
a touch screen display;
at least one processor;
a memory;
one or more programs,
wherein said one or more programs are stored in said memory and configured to be executed by said at least one processor to control said computer system to:
display a portion of displayable information in a nominal state on said touch screen display;
detect a movement of an object on or near said touch screen display;
responsive to said movement, detect a boundary limit of said displayable information; and
responsive to a detection of said boundary limit, display said portion of displayable information in a distorted state on said touch screen display, wherein said distorted state changes a shape of items of said portion of displayable information in a direction of said movement.

10. The system of claim 9 wherein said distorted state comprises a non-linear shift of said portion of displayable information.

11. The system of claim 9 wherein said distorted state comprises a shift in a direction of said movement.

12. The system of claim 9 wherein said distorted state comprises different portions of said portion of displayable information comprising different amounts of distortion.

13. The system of claim 9 wherein said distorted state comprises a shift directed to an intersection of said boundary limit and a line of said movement.

14. The system of claim 9 wherein said portion of displayable information comprises a picture.

15. An article of manufacture including a computer readable medium having instructions stored thereon that, responsive to execution by an electronic system, cause said electronic system to perform operations comprising:
displaying a portion of displayable information in a nominal state;
detecting a movement of an object on or near a touch screen display;
responsive to said movement, detecting a boundary limit of said displayable information; and
responsive to said detecting, displaying said portion of displayable information in a distorted state, wherein said distorted state simulates fabric stretching in a direction of said movement.

16. The article of manufacture of claim 15 wherein said portion of displayable information comprises at least one icon.

17. The article of manufacture of claim 16 wherein said at least one icon represents an application program (“app”).

18. The article of manufacture of claim 16 wherein said at least one icon is configured to launch software for playing an associated audio or video file.

19. The article of manufacture of claim 15 wherein said distorted state comprises a non-continuous shift of said portion of displayable information.

20. The article of manufacture of claim 15 further comprising responsive to cessation of said movement, displaying said portion of displayable information in said nominal state.
